(19) United States
(12) Patent Application Publication
(10) Pub. No.: US 2026/0127532 A1
(43) Pub. Date: May 7, 2026

(54) ONLINE PRESENCE RECOMMENDATION AND IMPLEMENTATION TOOL

(71) Applicant: Wix.com Ltd., Tel Aviv (IL)

(72) Inventors: Roni LAROM NOY, Ramat Hasharon (IL); Yoav JACOBSEN, Tzurit (IL); Haim AGAMI-TURJEMAN, Haifa (IL); Yaya Yael AARONSOHN, Herzliya (IL); Tal BIGELMAN, Tel Aviv (IL)

(21) Appl. No.: 19/379,796

(22) Filed: Nov. 5, 2025

Related U.S. Application Data
(60) Provisional application No. 63/717,376, filed on Nov. 7, 2024.

(51) Int. Cl. G06Q 10/0639; G06F 16/34; G06Q 10/0631

(52) U.S. Cl. CPC G06Q 10/0639; G06F 16/345; G06Q 10/063112

(57) ABSTRACT

A system to define features of online presences and match them to an entrepreneur's profile includes a high-performance metric analyzer, an online app summarizer, and a feature definer. The metric analyzer identifies high-performance online applications (HPOAs) by analyzing hosting platform data based on performance indicators. The app summarizer generates content summaries for these HPOAs, from which the feature definer defines specific business features. A matcher to match a profile of an entrepreneur to features of an HPOA includes an HPOA processor, an HPOA-based profiler, and an HPOA-based enterprise matcher. The processor uses this information to generate a feature database of the HPOAs. The profiler receives information about an entrepreneur's skills, hobbies, and interests to create a personal profile. Finally, the enterprise matcher matches the entrepreneur's profile with the set of features in the HPOA feature database to find alignments between the user and the high-performance application models.

### CROSS REFERENCE TO RELATED APPLICATIONS

This application claims priority from U.S. provisional patent application 63/717,376, filed Nov. 7, 2024, which is incorporated herein by reference.

### FIELD OF THE INVENTION

The present invention relates generally to online presence development tools and to personalized online presence recommendation and implementation systems in particular.

### BACKGROUND OF THE INVENTION

The job market is undergoing significant transformation due to recent technological advancements and global events. Experts predict substantial shifts in employment patterns over the coming years, with the need for many traditional roles declining while new opportunities emerge. This evolving landscape presents both challenges and opportunities for individuals seeking to establish or transition their careers.

In parallel with these changes, the digital economy continues to expand, with online presence becoming increasingly crucial for businesses or enterprises of all sizes. Websites serve as the foundation for many modern enterprises, acting as virtual storefronts, marketing platforms, and customer engagement hubs. The ability to establish and maintain an effective online presence has become a key factor in enterprise success across various industries.

The complexity of creating and managing a professional website has grown alongside its importance. Modern website management systems, such as the one illustrated in FIG. 1, to which reference is now made, demonstrate the intricate nature of these platforms. FIG. 1 shows a website management system 100 that includes multiple interconnected components: an object marketplace 5, a website manager 10 with its server 20, editor 30, and site generator 40, all interacting with a central website content management system (CMS) 50. This system supports various user interfaces for administrators 61, designers 62, and viewers 63, while also connecting to external systems 70. Parts of website management system 100 are described in the following U.S. Pat. Nos. 10,185,703, 9,805,134, 9,817,804, 10,209,966 and 10,509,850, and in U.S. patent application Ser. No. 18/665,423, filed May 15, 2024, all owned by Applicant and incorporated herein by reference.

Such comprehensive platforms highlight the technical challenges faced by individuals and enterprises when establishing their online presence.

Aspiring entrepreneurs, recently unemployed individuals, freelancers, and those seeking additional income streams often explore options for starting their own enterprises or transitioning into new career paths. However, the process of conceptualizing, launching, and managing an online enterprise can be complex and multifaceted. It typically involves identifying viable enterprise ideas, creating comprehensive execution plans, and implementing the necessary digital infrastructure, including navigating systems like the one depicted in FIG. 1.

Existing resources for enterprise planning and career guidance offer a range of tools and information. These may include generalized advice on entrepreneurship, market analysis tools, and platforms for building websites or online stores. Website building systems, in particular, have evolved to provide users with the ability to create and manage their online presence without extensive technical knowledge. However, these systems, while powerful, can still present a significant learning curve for many users.

### SUMMARY OF THE PRESENT INVENTION

There is therefore provided, in accordance with a preferred embodiment of the present invention, a system to define features of online presences. The system includes a high-performance metric analyzer, a high-performance online app (HPOA) summarizer, and a feature definer. The high-performance metric analyzer analyzes hosting platform data to identify HPOAs as a function of performance indicators and stores information about the HPOAs in a HPOA database. The HPOA summarizer generates summaries of content of the high-performance online applications. The feature definer defines features of the HPOA at least from the summaries.

Moreover, in accordance with a preferred embodiment of the present invention, the performance indicators are at least one of, traffic, income, and end user engagement.

Further, in accordance with a preferred embodiment of the present invention, the HPOA summarizer utilizes a large language model (LLM) to generate the summaries of content of the high-performance online applications.

Still further, in accordance with a preferred embodiment of the present invention, the features include at least one enterprise phrase and at least one enterprise definition used to define or describe the enterprise of one of the high-performance online applications.

Additionally, in accordance with a preferred embodiment of the present invention, the system also includes an aggregate by feature module. The aggregate by feature module compiles and organizes the features across multiple high-performance online applications.

Moreover, in accordance with a preferred embodiment of the present invention, the aggregate by feature module determines a term frequency-inverse document frequency (TF-IDF) per high-performance online application.

Further, in accordance with a preferred embodiment of the present invention, the system also includes an enterprise aspect extractor, and a plurality of aspect databases. The enterprise aspect extractor receives data from the HPOA database and extracts various enterprise aspects from the high-performance online applications. The plurality of aspect databases stores specific aspects of enterprises extracted by the enterprise aspect extractor.

There is therefore provided, in accordance with a preferred embodiment of the present invention, a matcher to match a profile of an entrepreneur to features of a high-performance online app (HPOA). The matcher includes a HPOA processor, an HPOA-based profiler, and an HPOA-based entrepreneur to enterprise matcher. The HPOA processor extracts a set of HPOAs at least from databases of website and online application building systems and of hosting platforms and generates an HPOA feature database of features of the HPOAs from the extracted set. The HPOA-based profiler is at least fine-tuned with at least a profiler portion of the HPOAs, receives from an entrepreneur information about his/her skills, hobbies, and interests, and generates an entrepreneur profile in response. The HPOA-based entrepreneur to enterprise matcher matches the entrepreneur profile with a set of features of the HPOA feature database.

Still further, in accordance with a preferred embodiment of the present invention, the matcher also includes a HPOA-based online presence selection builder, and a HPOA-based selected online presence bundle creator. The HPOA-based online presence selection builder is at least fine-tuned with at least operational app and marketing portions of the HPOAs, receives the set of features from the matcher, and generates a set of candidate enterprises from the set of features. The HPOA-based selected online presence bundle creator is at least fine-tuned with at least a bundle data portion of the HPOAs and constructs a comprehensive online presence bundle for a selected enterprise from among the set of candidate enterprises. The bundle creator generates at least a business plan, a website, and a mobile app for the selected enterprise.

There is therefore provided, in accordance with a preferred embodiment of the present invention, a method to define features of online presences. The method includes analyzing hosting platform data to identify high-performance online applications (HPOAs) as a function of performance indicators, storing information about the HPOAs in a HPOA database, generating summaries of content of the HPOAs, and defining features of the HPOAs at least from the summaries.

Additionally, in accordance with a preferred embodiment of the present invention, the performance indicators are at least one of, traffic, income, and end user engagement.

Moreover, in accordance with a preferred embodiment of the present invention, the generating utilizes a large language model (LLM).

Further, in accordance with a preferred embodiment of the present invention, the defining includes defining at least one enterprise phrase and at least one enterprise definition used to describe the enterprise of one of the high-performance online applications.

Still further, in accordance with a preferred embodiment of the present invention, the method also includes compiling and organizing the features across multiple HPOAs.

Additionally, in accordance with a preferred embodiment of the present invention, the compiling and organizing includes determining a term frequency-inverse document frequency (TF-IDF) per high-performance online application.

Moreover, in accordance with a preferred embodiment of the present invention, the method also includes extracting various enterprise aspects from each HPOA stored in the HPOA database, and storing specific aspects of enterprises in separate aspect databases.

There is therefore provided, in accordance with a preferred embodiment of the present invention, a method to match a profile of an entrepreneur to features of a high-performance online app (HPOA). The method includes extracting a set of HPOAs from databases and generating an HPOA feature database of features of the HPOAs from the extracted set, receiving from an entrepreneur information about their skills, hobbies, and interests and generating an entrepreneur profile in response, where the generating is at least fine-tuned with a profiler portion of the HPOAs, and matching the entrepreneur profile with a set of features of the HPOA feature database.

Further, in accordance with a preferred embodiment of the present invention, the method also includes generating a set of candidate enterprises from the set of features resulting from the matching, where the generating is at least fine-tuned with operational app and marketing portions of the HPOAs, and constructing a comprehensive online presence bundle for a selected enterprise from among the set of candidate enterprises by generating at least a business plan, a website, and a mobile app for the selected enterprise. The constructing is at least fine-tuned with a bundle data portion of the HPOAs.

There is therefore provided, in accordance with a preferred embodiment of the present invention, a system for recommending and implementing an online presence. The system includes a performance metric analyzer, a database, an HPOA processor, and an online presence creator. The performance metric analyzer analyzes data regarding a plurality of existing online applications to identify a set of high-performance online applications (HPOAs) based on performance metrics. The database stores the set of HPOAs. The HPOA processor processes the HPOAs from the database to generate at least one enterprise recommendation based on personal information of an entrepreneur. The online presence creator creates an online presence for the entrepreneur based on a selection of the at least one enterprise recommendation.

Moreover, in accordance with a preferred embodiment of the present invention, the performance metrics include at least one of, traffic levels, income levels, gross payment volume (GPV), or user engagement.

Further, in accordance with a preferred embodiment of the present invention, the performance metric analyzer analyzes data from a content management system (CMS) of a hosting platform.

Still further, in accordance with a preferred embodiment of the present invention, the HPOA processor includes an enterprise aspect extractor, and a summary processing module. The enterprise aspect extractor extracts enterprise aspects from the HPOAs. The summary processing module generates summaries and defines features of the HPOAs.

Additionally, in accordance with a preferred embodiment of the present invention, the summary processing module includes a high-performance online app summarizer which utilizes a large language model (LLM) to generate the summaries.

Moreover, in accordance with a preferred embodiment of the present invention, the personal information is obtained via a chat-based AI system that engages the entrepreneur in a conversation to extract skills, interests, and goals.

Further, in accordance with a preferred embodiment of the present invention, the online presence created by the online presence creator includes at least one of a business plan, a website, or a mobile app.

Still further, in accordance with a preferred embodiment of the present invention, the online presence creator includes an entrepreneur to enterprise matcher, an online presence selection builder, and a selected online presence bundle creator. The entrepreneur to enterprise matcher matches the personal information with features of the HPOAs. The online presence selection builder generates a curated list of candidate online presence options. The selected online presence bundle creator constructs a comprehensive online presence bundle for a selected enterprise.

There is therefore provided, in accordance with a preferred embodiment of the present invention, a method for recommending and implementing an online presence. The method includes analyzing data regarding a plurality of existing online applications to identify a set of high-performance online applications (HPOAs) based on performance metrics, storing the set of HPOAs, processing the HPOAs to generate at least one enterprise recommendation based on personal information of an entrepreneur, and creating an online presence for the entrepreneur based on a selection of the at least one enterprise recommendation.

Additionally, in accordance with a preferred embodiment of the present invention, analyzing is based on performance metrics including at least one of, traffic levels, income levels, gross payment volume (GPV), or user engagement.

Moreover, in accordance with a preferred embodiment of the present invention, analyzing includes analyzing data from a content management system (CMS) of a hosting platform.

Further, in accordance with a preferred embodiment of the present invention, processing the HPOAs includes extracting enterprise aspects from the HPOAs, and generating summaries and defining features of the HPOAs.

Still further, in accordance with a preferred embodiment of the present invention, generating the summaries is performed utilizing a large language model (LLM).

Additionally, in accordance with a preferred embodiment of the present invention, the personal information is obtained by engaging the entrepreneur in a conversation using a chat-based AI system to extract skills, interests, and goals.

Moreover, in accordance with a preferred embodiment of the present invention, creating an online presence includes creating at least one of a business plan, a website, or a mobile app.

Further, in accordance with a preferred embodiment of the present invention, creating an online presence includes matching the personal information with features of the HPOAs, generating a curated list of candidate online presence options, and constructing a comprehensive online presence bundle for a selected enterprise.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustration of a prior art website management system;

FIG. 2 is a simplified block diagram illustration of an online presence recommendation and implementation tool, constructed and operative according to an embodiment of the present invention;

FIG. 3 is a block diagram illustration of key components forming part of the tool of FIG. 2;

FIG. 4 is a block diagram illustration showing components forming part of the HPOA processor of FIG. 3;

FIG. 5 is a block diagram illustration showing components forming part of an online presence creator of FIG. 3;

FIG. 6A is a block diagram illustration of components of an entrepreneur to enterprise matcher of FIG. 5;

FIG. 6B is a screen shot illustration of a chat interface useful in the matcher of FIG. 6A;

FIG. 6C is a screen shot illustration of a user profile generated by the matcher of FIG. 6A;

FIG. 6D is a block diagram illustration of an entrepreneur to enterprise AI matcher of FIG. 6A;

FIG. 7A is a block diagram illustration of the components of an online presence selection builder of FIG. 5;

FIG. 7B is a screen shot illustration of an interface for selecting a business idea, useful in the builder of FIG. 7A;

FIG. 7C is a screen shot illustration of a detailed business idea report generated by the builder of FIG. 7A;

FIG. 8 is a block diagram illustration of the components of a selected online presence bundle creator of FIG. 5; and

FIG. 9 is a screenshot illustration of a business dashboard generated by the creator of FIG. 2.

It will be appreciated that for simplicity and clarity of illustration, elements shown in the Figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that websites contain a wealth of information about a business or enterprise—not just about what is being sold or offered, but also about the skills and interests of the founders and main employees. Furthermore, website building systems that also host online applications (websites and/or mobile apps) have access to a vast amount of information about enterprises, including the range of products, prices, customers, customer locations and loyalty, amount of sales, annual income, and more.

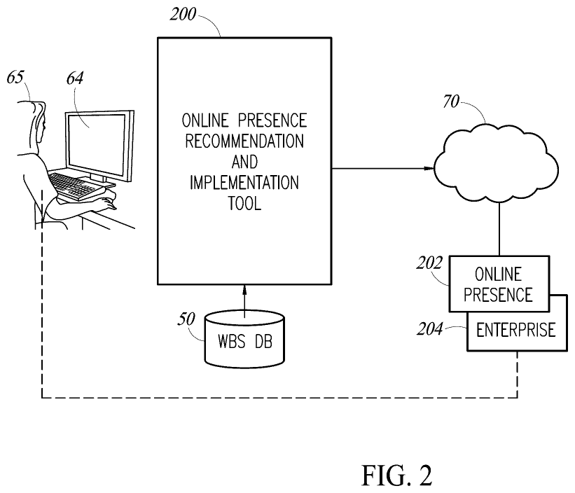

Applicant has realized that this information can be leveraged to determine which online applications are high-performance in their respective fields. Moreover, a smart online presence recommendation and implementation tool can combine this wealth of data to provide recommendations for an online presence tailored to a person's interests and abilities, as well as for its associated enterprise. This concept is illustrated in FIG. 2, to which reference is now made, which shows an online presence recommendation and implementation tool 200 generating both an online presence 202 and an enterprise 204 for an entrepreneur 65.

Applicant has realized that it is not sufficient to simply ask a person to list their skills and hobbies. These often only emerge through conversation. Thus, a different approach is needed to extract and understand a person's full range of capabilities and interests. As depicted in FIG. 2, to which reference is now made, this interaction may occur through a user interface 64, allowing for a more dynamic and thorough exploration of the entrepreneur's profile.

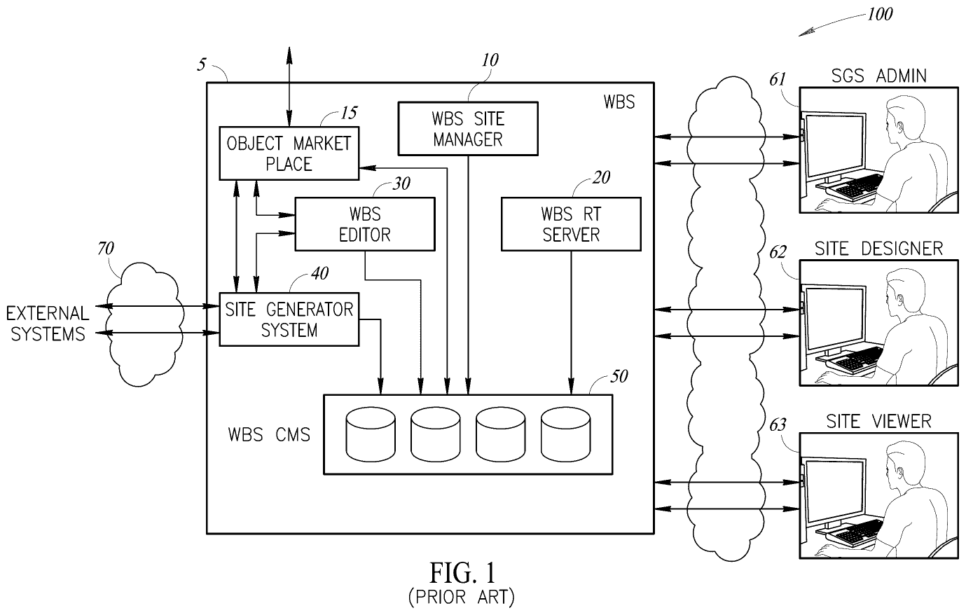

Applicant has realized that a high-performance online presence has many parts, each of which affects a different aspect of the online presence and/or enterprise. These aspects may include the characteristics of the employees, owners, and/or founders (i.e., the human resources), the types of services offered, the types of operational apps used for the services, the marketing plan, the business plan, and/or the branding. The online presence recommendation and implementation tool 200 may be designed to address these multiple aspects, drawing from the wealth of data available in the website content management system 50 (FIG. 1) about the online application (e.g. from the website editor 30, which may also edit a mobile application) and about its operation (e.g. from the WBS RT (run time) server 20 which may support a website and/or a mobile application).

As described hereinbelow, the present invention may employ one or more artificial intelligence (AI) models which require training. “Training” refers to fitting model parameters (e.g., weights) on a set of examples (the training dataset). Depending on the learning paradigm—supervised, self-supervised, unsupervised, or reinforcement—the model computes outputs for each example and a loss function quantifies the difference between the outputs and the desired behavior. An optimizer (e.g., stochastic gradient descent or a variant) updates the parameters to reduce the loss. In some embodiments, the model supports online or continual learning, in which parameters are updated incrementally as new data are observed. In other embodiments, the model remains fixed at “inference” time and adaptation is achieved via retrieval or context conditioning without changing parameters.

Large language models (LLMs) are pretrained on large text corpora using self-supervised objectives such as next-token prediction, yielding broad linguistic and domain coverage (including, where present in the corpora, multiple languages). LLMs may be adapted to specific domains or tasks by fine-tuning on smaller domain-specific datasets, by instruction tuning and/or reinforcement learning from human or AI feedback, by parameter-efficient adaptation techniques (e.g., adapters or low-rank adaptation), and/or by retrieval-augmented generation that conditions on external knowledge sources.

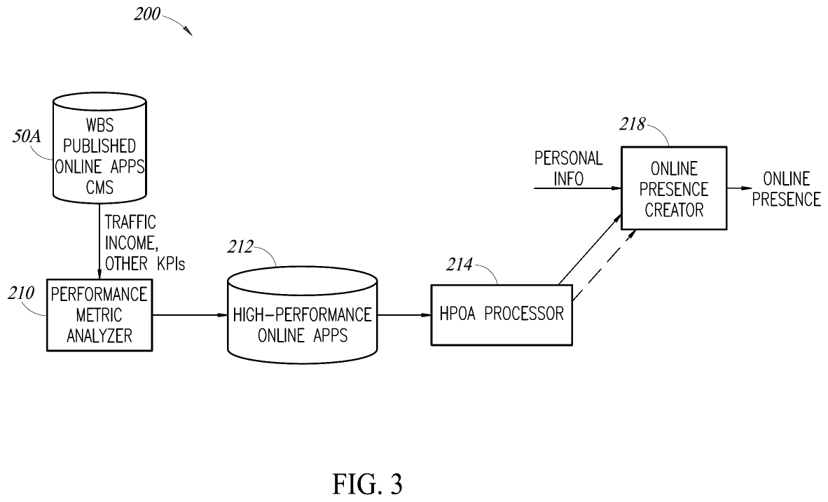

FIG. 3, to which reference is now made, illustrates a block diagram of online recommendation and implementation tool 200. Online recommendation and implementation tool 200 may comprise a performance metric analyzer 210, a high-performance online apps (HPOA) database 212, an HPOA processor 214 to provide multiple enterprise recommendations to entrepreneur 65 (FIG. 2) using tool 200, and an online presence creator 218 to create an online presence from the entrepreneur's selected enterprise recommendation.

Performance metric analyzer 210 may receive data, such as that stored in the content management system (CMS), here labeled 50A, of the hosting platform, about the published online apps, which may represent a vast array of existing websites and mobile applications built and hosted on the platform. Performance metric analyzer 210 may process the information in CMS 50A to identify high-performance online applications based on various key performance indicators (KPIs), such as traffic levels, income levels, gross payment volume (GPV), price per unit/service, user engagement, and other relevant metrics available to hosting platforms.

As is known in the art, traffic data formulas are used to calculate traffic volumes, predict traffic flow, and analyze traffic patterns. A common formula is the Annual Average Daily Traffic (AADT), which is the total traffic volume over a year divided by the number of days in that year (365 or 366). Traffic flow is often defined as the product of traffic density and velocity.

The metrics may be defined by enterprise segment and/or by country. For example, a site or mobile application which is above the median GPV or in the top 25% of traffic for its segment and/or market and a site or mobile application which is in the top 25% of traffic for its segment and/or market may be defined as a high-performance enterprise.

Performance metric analyzer 210 may use statistical methods or an artificial intelligence (AI) model to determine other factors, such as required offline presence or team size. This information may be publicly available, such as via the Internet, and/or in other databases.

Performance metric analyzer 210 may additionally integrate market intelligence data which may be available in WBS 100. For example, performance metric analyzer 210 may analyze online apps to understand their actions, such as using social media, connecting a domain, utilizing SEO, using apps, and employing Google Ads. Other metrics may include SEO keyword search volume, keyword difficulty, and ad spending competition levels. Performance metric analyzer 210 may find this information in a BI (Business Intelligence) repository of WBS 100, which may list various actions performed during editing (stored in an editing history repository) as well as deployment, promotion, and operation of the published online application. Performance metric analyzer 210 may also access market data, such as those provided by “Google Trends”, commercially available from Google Inc. of the USA.

Based on these metrics, performance metric analyzer 210 may calculate scores for the metrics of each online app and may use this score to identify the highest performing online apps, storing those with the best scores in high-performance online app database 212.

This detailed analysis of high-performance online apps may help tool 200 to generate enterprise ideas that are more likely to be viable and successful by focusing on existing online apps that have already demonstrated effectiveness—while preserving the legal rights of these existing online apps and their owners (such as intellectual property (IP), confidentiality, and privacy rights) through aggregation and anonymized values.

High-performance online apps (HPOA) database 212 may store the results of the analysis performed by performance metric analyzer 210. This database may contain valuable information about features, design elements, content strategies, and enterprise models that contribute to the success of these applications.

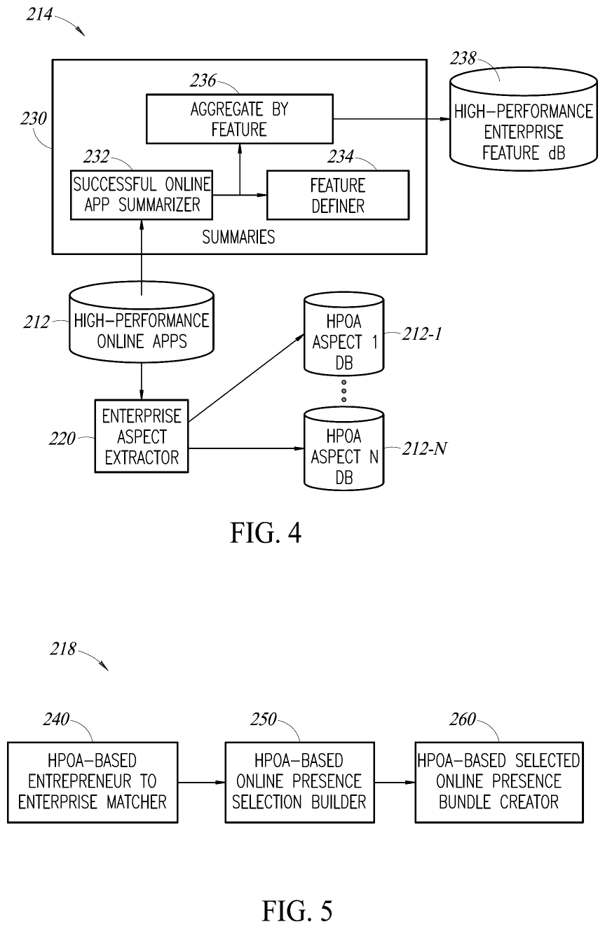

HPOA processor 214 may serve as a crucial component within tool 200. It may extract various aspects of the enterprises from high-performance online apps stored in database 212. These extracted aspects may be used for later training of various AI models within system 200. Additionally, HPOA processor 214 may define enterprise features of the HPOAs, which may be utilized for subsequent matching to entrepreneurs interested in starting an enterprise. The detailed operation of HPOA processor 214 is further illustrated in FIG. 4, discussed hereinbelow.

Online presence creator 218 may interface with entrepreneurs, potentially through user interface 64 shown in FIG. 2. As described in more detail hereinbelow, online presence creator 218 may utilize sophisticated chat-based AI systems to engage entrepreneurs in conversations, extracting information about their skills, interests, and enterprise goals.

FIG. 4, to which reference is now made, illustrates a detailed block diagram of HPOA processor 214. HPOA processor 214 may comprise an enterprise aspect extractor 220, a summary processing module 230, and multiple aspect databases 212-1 through 212-N. These components work together to analyze high-performance online apps, extract relevant enterprise aspects, and process this information for later use in the recommendation system.

Enterprise aspect extractor 220 may receive data from high-performance online apps database 212, which, as described hereinabove, may store information about high-performing websites and applications as identified by performance metric analyzer 210. Enterprise aspect extractor 220 may process this data to identify, tag and extract various enterprise aspects from each high-performance online app, storing these extracted enterprise aspects separately in aspect databases 212-1 through 212-N. Each of these databases 212-i may focus on a specific aspect of the enterprise, such as marketing strategies, operational processes, customer engagement techniques, revenue models, characteristics of the founders and/or employees, etc.

Summary processing module 230 may comprise a high-performance online app summarizer 232, a feature definer 234, and an aggregate by feature module 236. High-performance online app summarizer 232 may utilize the summarizing ability of a large language model (LLM) such as ChatGPT, commercially available from OpenAI of the USA, to summarize the content of the online app (website or mobile app) and may create summaries of the content of each high-performance online app, highlighting at least key characteristics and performance indicators. Feature definer 234 may use the summaries to describe a “business term” as a (typically short) paragraph. “Business term” may include business phrases and business definitions used to define or describe the enterprise. Feature definer 234 may then use statistics to identify and categorize distinct features from these business terms that contribute to the success or high performance of these online applications.

Aggregate by feature module 236 may then use an aggregator algorithm, such as is known in the art, to run a query containing filters and logic to compile and organize these features across multiple high-performance apps, identifying common patterns and unique strategies. For instance, module 236 may determine each high-performance online application's term frequency using an inverse document frequency (TF-IDF), a widely used statistical method to measure how important a term is within a document relative to a collection of documents. Module 236 may store, per business term, a comprehensive set of features, summaries and their TF-IDF values for various terms therein, online apps and other components of high-performance enterprises, in a high-performance enterprise feature database 238, to be used in the matching and recommendation processes as described in more detail hereinbelow.

It will be appreciated that HPOA processor 214 may play a crucial role in transforming raw data about high-performance online apps into structured aspects and key features. It will further be appreciated that online recommendation and implementation tool 200, with its HPOA processor 214, may enable generally accurate and personalized matching between entrepreneur profiles and high-performance enterprise models.

FIG. 5, to which reference is now made, illustrates a block diagram of online presence creator 218. Online presence creator 218 may comprise an HPOA-based entrepreneur to enterprise matcher 240, an HPOA-based online presence selection builder 250, and an HPOA-based selected online presence bundle creator 260. These components may work together to analyze input from the entrepreneur, match the input with the relevant features of a high-performance online app, and generate a proposed comprehensive online presence for a selected enterprise having the relevant features.

HPOA-based entrepreneur to enterprise matcher 240 may interface with entrepreneur 65, potentially through user interface 64 (FIG. 2). Matcher 240 may utilize AI systems, such as those based on chats, to engage entrepreneur 65 in conversations, extracting information about his/her skills, interests, and goals from these conversations. Matcher 240 may then process this information alongside data from high-performance online apps (HPOAs), stored in the various HPOA aspect databases 212 and in high-performance enterprise feature database 238, to identify potential enterprise matches for the entrepreneur.

HPOA-based online presence selection builder 250 may receive the output from matcher 240 and may further refine the selection of potential online presence options. Builder 250 may analyze the matched enterprise features in greater detail, considering factors such as market trends, competition, and the entrepreneur's specific capabilities. This component may generate a curated list of candidate online presence options tailored to the entrepreneur's profile.

HPOA-based selected online presence bundle creator 260 may take a selected enterprise from builder 250 and may construct a comprehensive online presence bundle for the selected enterprise. This bundle may include detailed recommendations for an online presence, including online presence design (of a website and/or mobile application), content strategy, service offerings, business model, and operational tools. The online presence design may comprise content, layout, and visuals tailored to the selected enterprise, as well as logic and back-end and front-end elements. It may also comprise apps, add-ons, plug-ins, third-party applications, and other site extension elements, as well as anything necessary to effectively implement them, such as any relevant third-party tools, services and interfaces, technical elements, as well as the required completion of registration, security issues, access keys provisioning, and related processes.

The bundle may also comprise additional variants for various online presence areas, allowing specific customization for the entrepreneur. This may also include additional suggestions for further options and extensions, which are not included in the current bundle but are suggested to the entrepreneur as future options. In some embodiments, tool 200 may generate only a partial area or section of a website or online presence. The generated portion may be embedded, merged, or added into an existing site or other presence, such as where entrepreneur 65 has a substantial personal site and wants to augment it with a newly created section about the new enterprise.

The bundle may also comprise a suggestion for a name of the enterprise, an available domain name suggestion, a logo (based on or related to the suggested enterprise name), and a marketing action plan that may be implemented by the entrepreneur, an AI agent, as defined hereinbelow, or a persona specializing in marketing.

Creator 260 may ensure that each bundle is cohesive and aligned with the entrepreneur's goals and the characteristics of high-performance online apps in similar domains.

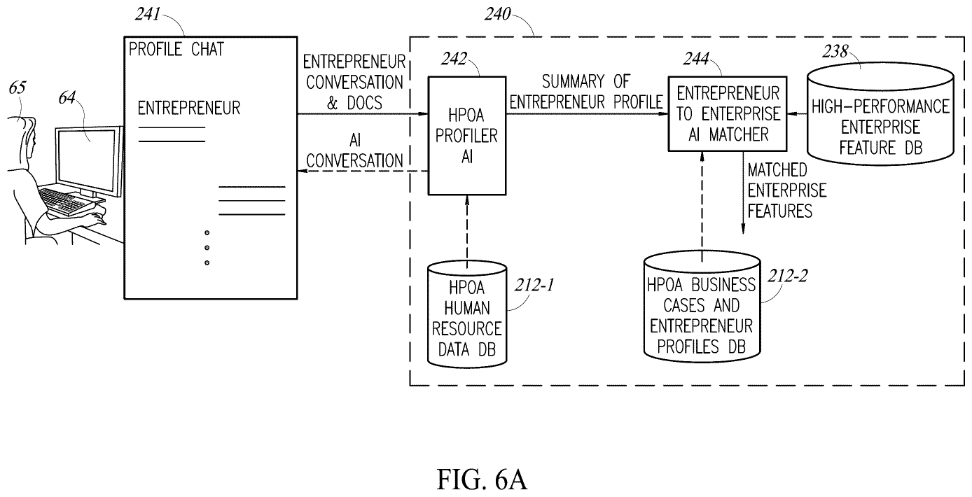

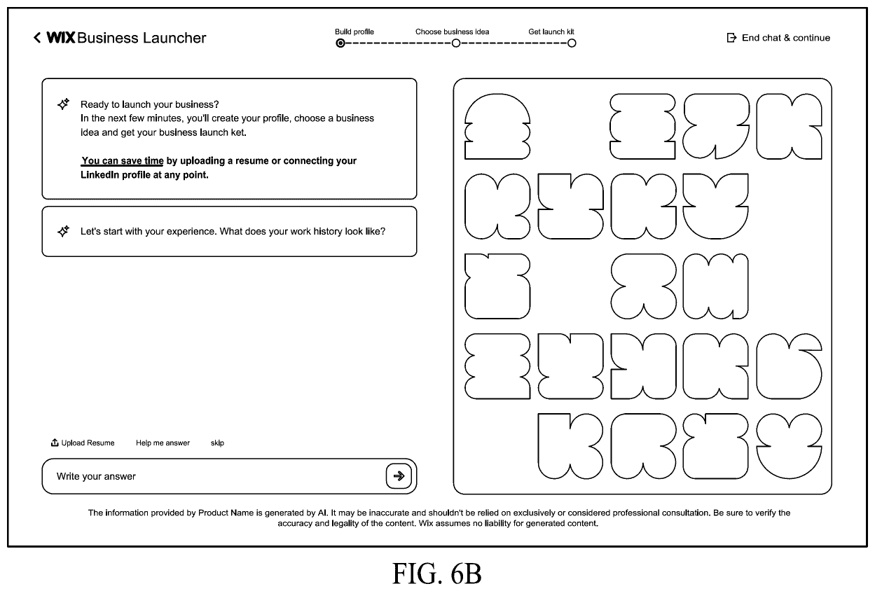

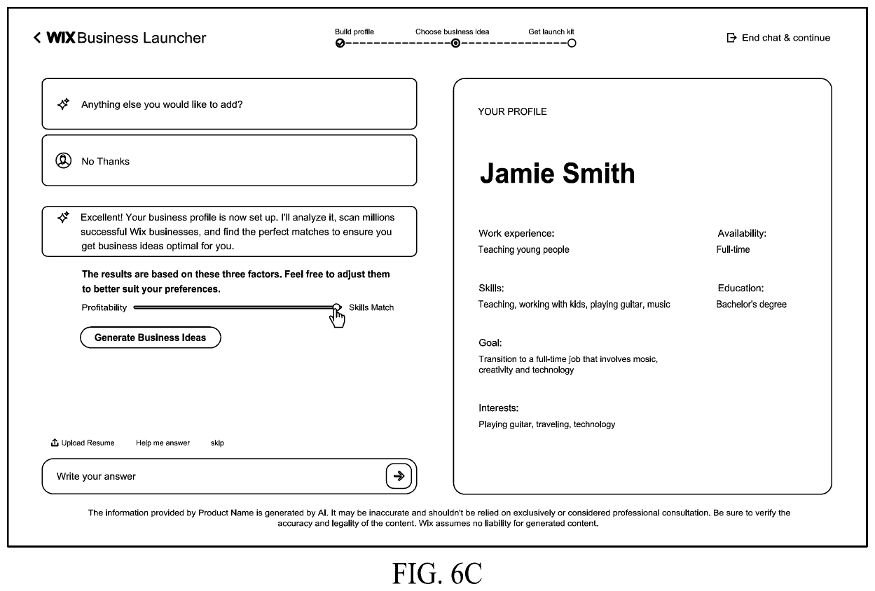

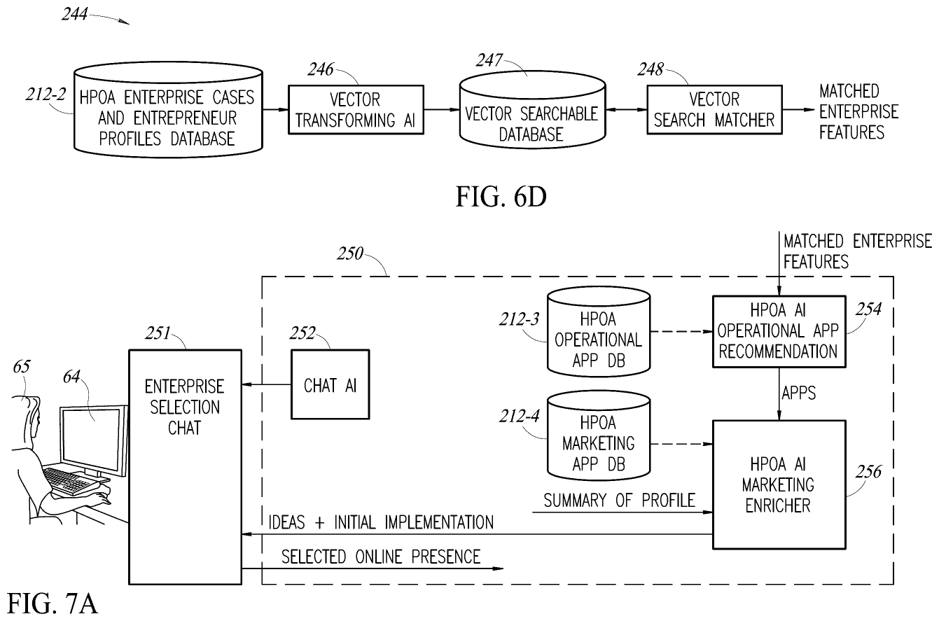

FIGS. 6A, 6B and 6C, to which reference is now made, illustrate a detailed block diagram of enterprise matcher module 240, an exemplary start of a chat, and an exemplary fully structured profile of the entrepreneur, respectively.

FIG. 6A shows the key components and data flow within enterprise matcher module 240, emphasizing how it processes entrepreneur information to generate a profile and to match it with high-performance enterprise features. Enterprise matcher module 240 may comprise a profile chat 241, an HPOA profiler AI 242, and an entrepreneur to enterprise AI matcher 244. These components work together to engage entrepreneur 65 in conversation, extract relevant information, and match the entrepreneur's profile with high-performance enterprises.

Profile chat 241 may serve as the primary interface between entrepreneur 65 and tool 200. An exemplary chat interface is shown in FIG. 6B. It may utilize HPOA profiler AI 242 to conduct dynamic, AI-driven conversations with entrepreneur 65. HPOA profiler AI 242 may employ natural language processing techniques to understand and interpret responses from entrepreneur 65, asking open-ended questions and follow-ups to gather comprehensive information about the entrepreneur's skills, experiences, and enterprise goals.

HPOA profiler AI 242 may be any suitable AI model, such as an LLM or an AI agent, trained with deep knowledge in extracting details from resumes, interviews, and surveys, and fine-tuned with data from HPOA human resource database 212-1 that includes work experience, goals, availability, skills, and hobbies. The fine-tuning may be supervised with sample person texts annotated for these specific fields. Human resource professionals and data extraction experts may review outputs and may refine the model of HPOA profiler AI 242 to ensure accurate, structured, and actionable responses. The model may be validated with real-world user profile extraction tasks. In addition, HPOA profiler AI 242 may be continuously updated to reflect diverse inputs and current trends.

By training on this data, HPOA profiler AI 242 may develop a deep understanding of the attributes that contribute to the success of enterprises, enabling it to ask more relevant and insightful questions during interactions with the entrepreneur. As the conversation progresses, HPOA profiler AI 241 may create a summary of the entrepreneur profile, an exemplary version of which is shown in FIG. 6C. This summary may include key information about the entrepreneur, such as a user ID, the entrepreneur's name, geographical location, the entrepreneur's work experience, skills (declared and implied), website/mobile application skills, education, availability (full-time/part-time/passive income), goals, hobbies, and interests. In the example of FIG. 6C, the entrepreneur, Jamie Smith, has skills in teaching, working with kids, playing guitar and music, and is interested in getting a full-time job that involves music, creativity, and technology. If desired, the entrepreneur profile summaries may be stored (not shown).

In one embodiment, HPOA profiler AI 242 may additionally comprise a keeper prompt that may observe each interaction between the entrepreneur and chat 241. The keeper prompt may be operative to remove or filter prohibited illegal content or anything that might be interpreted as legally prohibited content. This could also apply to “limited” content, which is legal in some jurisdictions and illegal in others or may have other limiting conditions (e.g., handgun sales).

Entrepreneur to enterprise AI matcher 244, shown in FIG. 6D to which reference is now made, may comprise a vector transforming AI 246, which may be an appropriate LLM, trained on entrepreneur-enterprise pairs of data in HPOA enterprise cases and entrepreneur profiles database 212-2 and may transform the entrepreneur profile and the enterprise features into vector representations, stored inside a vector searchable database 247. As described in more detail hereinbelow, entrepreneur to enterprise AI matcher 244 may also comprise a vector search matcher 248 to search vector searchable database 247 to find a set of enterprise features to match the vector form of the entrepreneur profile, which may provide more precise matching between entrepreneur skills and/or interests and viable enterprise features.

Entrepreneur to enterprise AI matcher 244 may identify potential matches between the entrepreneur's capabilities and proven enterprise models, considering factors such as skill alignment, market trends, and the entrepreneur's stated goals. Matcher 244 may initially find the closest semantic matches for the entrepreneur's profile and may then use a recommendation engine to find the best match within the matched results. The recommendation engine may utilize any recommendation algorithm, such as is known in the art, that can use statistical methods or AI to perform matches.

HPOA enterprise cases and entrepreneur profiles database 212-2 may contain a wealth of information about high-performance enterprises and their corresponding entrepreneur profiles. It may have the online app summaries and descriptions, produced by summarizer 232, and may provide them to fine-tune the AI model of entrepreneur to enterprise AI matcher 244 to map entrepreneur profiles to relevant enterprise terms. The training process may use supervised learning to ensure precise enterprise term association and may use experts to validate and refine results to maintain structured, actionable insights. Moreover, HPOA enterprise cases and entrepreneur profiles database 212-2 may be continuously updated to reflect evolving enterprise trends and enhance recommendation.

After training on this data, entrepreneur to enterprise AI matcher 244 may perform sophisticated matching algorithms to align entrepreneur profiles with suitable enterprise opportunities based on patterns and correlations observed in high-performance cases. For example, entrepreneur to enterprise AI matcher 244 may perform a vector search in high-performance enterprise feature database 238. Vector search is a method of information retrieval where data (like text, images, or other content) are represented as vectors, or numerical representations, and then searched for similar or related items based on the proximity of these vectors in a high-dimensional space. It is used to find items that are semantically similar, even if the exact words or phrases don't match.

Entrepreneur to enterprise AI matcher 244 may then calculate a score for each set of matched enterprise features to identify the best overall ideas and those that best match entrepreneur 65.

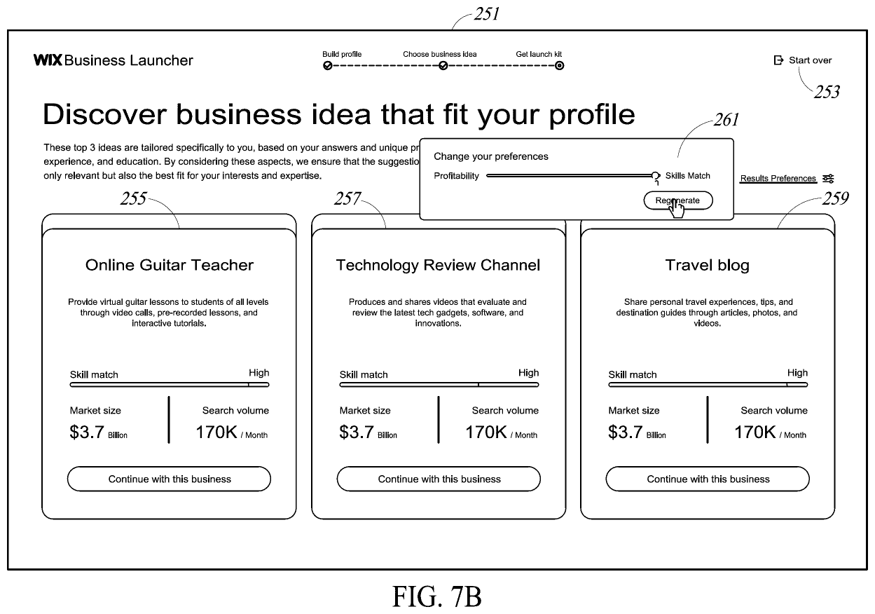

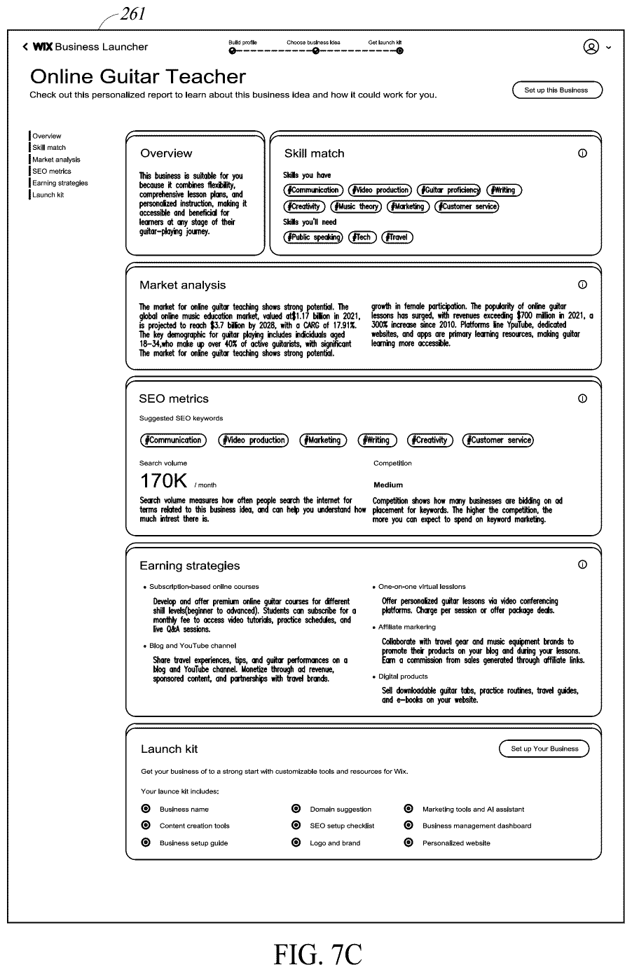

FIGS. 7A, 7B, and 7C, to which reference is now made, illustrate the components and user interfaces of HPOA-based online presence selection builder 250. Presence builder module 250 may comprise a chat AI 252 communicating with entrepreneur 65 via an enterprise selection chat AI 251, an HPOA AI operational app recommendation unit 254 and an HPOA AI marketing enricher 256. HPOA AI operational app recommendation unit 254 may be any suitable AI agent which may be fine-tuned with data from HPOA operational app database 212-3 and may use the matched enterprise features from matcher 244 to find relevant HPOA operational apps for the matched ideas.

An AI agent is a software-implemented computational entity configured to autonomously perceive input data from its environment (including digital, physical, or simulated domains), process the data using one or more machine learning, rule-based, statistical, or symbolic reasoning techniques, and execute goal-directed actions or generate outputs in response to the data.

The AI agent may operate continuously or in discrete instances, may learn from historical or real-time inputs, and may update its internal models or policies dynamically. The agent can be embodied in standalone software, embedded systems, distributed cloud environments, or hardware-integrated systems, and may include components such as inference engines, training subsystems, decision-making modules, and interaction interfaces (e.g., via natural language, API, sensors, or actuators).

HPOA AI marketing enricher 256 may be any suitable AI agent which may be fine-tuned with data from HPOA marketing app database 212-4. Enricher 256 may use the entrepreneur's profile summary as well as the HPOA marketing data from database 212-4 which are associated with those matched enterprise features to generate a marketing style to entrepreneur 65. The output may be a set of recommended online presences matched to the entrepreneur's interests and abilities and enriched with more data, like suggested SEO keywords, earning strategies, notes about why this idea fits the user, etc. HPOA AI marketing enricher 256 may limit its display to the top N ranked online presences, where N may be less than 5, typically as a function of how well the online presences matched the entrepreneur's interests and abilities. For each online presence, HPOA marketing enricher 256 may store the associated online presences and other elements as an enterprise profile card to allow the entrepreneur to browse, edit, and annotate the online presences.

The recommendations may be provided to enterprise selection chat 251, and chat AI 252 may discuss the recommendations with entrepreneur 65 who may then select the online presence of most interest to him/her. The selection, as well as the operational apps associated with it, may be provided as enterprise profile cards, to online presence creator 260.

FIG. 7B, to which reference is now briefly made, illustrates an exemplary state page on chat 251 for Jamie Smith of FIG. 6B, which may be generated by presence builder module 250. This interface may display multiple enterprise profile options arranged vertically, with a “start over” option 253 at the top of the display. The state page may further comprise a weighting control 261 enabling entrepreneur 65 to bias the recommendations between personalization (i.e. closer match to the entrepreneur's skills) and predicted enterprise-success metrics (e.g., closer match traffic/GPV/market opportunity, which may indicate profitability). Adjusting the weighting control may update the set and ranking of the displayed cards.

The state page may present multiple distinct enterprise profile cards. FIG. 7B shows three exemplary cards: an Online Guitar Teacher profile 255, a Technology Review Channel profile 257, and a Travel blog profile 259. Each profile card may contain similar layout elements including a skill match indicator, a search volume indicator, and a market size indicator, which shows $3.7 billion for all 3 profile cards. This presentation format may allow the entrepreneur to easily compare different enterprise opportunities based on key metrics, such as market size and search volume.

FIG. 7C, to which reference is now made, shows a more detailed listing 261 for an online enterprise for a guitar teacher. This interface may display various sections including an overview, skill match analysis, market analysis, SEO metrics, earning strategies, and a launch kit.

The interface may show a search volume indicator, listed in FIG. 7C as 170K, which may represent monthly search volume metrics for relevant keywords in this domain. The skill matching section may display required and desired skills for the enterprise, including communication, video production, and customer service capabilities.

The market analysis section may provide information about the online guitar teaching market, including growth projections and market size data. The SEO metrics section may display suggested keywords and competition analysis. The earning strategies section may outline various revenue generation methods, including subscription-based online courses and one-on-one virtual lessons.

The listing may conclude with a launch kit section that may detail the included enterprise tools and resources, such as the recommended operational apps from HPOA AI operations app recommendation unit 254. This comprehensive presentation of enterprise-specific information may provide entrepreneur 65 with a clear understanding of what's involved in launching and operating this particular online enterprise.

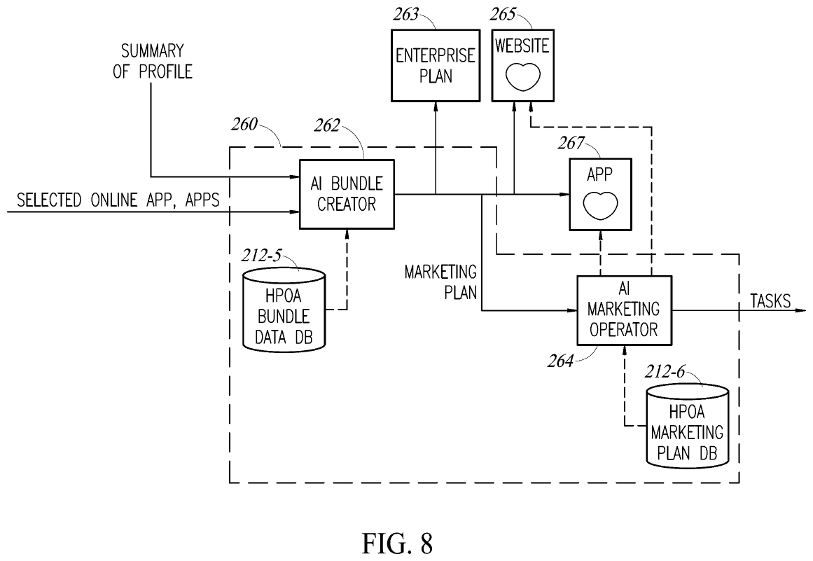

FIG. 8, to which reference is now made, is a block diagram of bundle creator module 260. Bundle creator module 260 may generate the online presence and enterprise implementation for the entrepreneur's selected enterprise.

Bundle creator module 260 may comprise an AI bundle creator 262 and an AI marketing operator 264, both of which may be implemented with an AI agent. AI bundle creator 262 may be fine-tuned with the data stored in HPOA bundle data database 212-5, which may provide data input for the creation process. HPOA bundle data database 212-5 may contain comprehensive information about high-performance online enterprises, including their operational structures, marketing strategies, logos and digital assets. This data may inform the creation of tailored enterprise plans and online presence components.

AI bundle creator 262 may generate a logo, a brand (color palette, fonts, etc.), and an enterprise plan 263, and may create a basic website 265 and a mobile app 267 that utilize the logo and brand, including filling in relevant information gleaned from the entrepreneur's profile summary. AI bundle creator 262 may also use a site generator 40 (FIG. 1) to publish the website 265 and the mobile app 267 with the relevant operational apps for this enterprise installed thereon. The result may be an initial online presence.

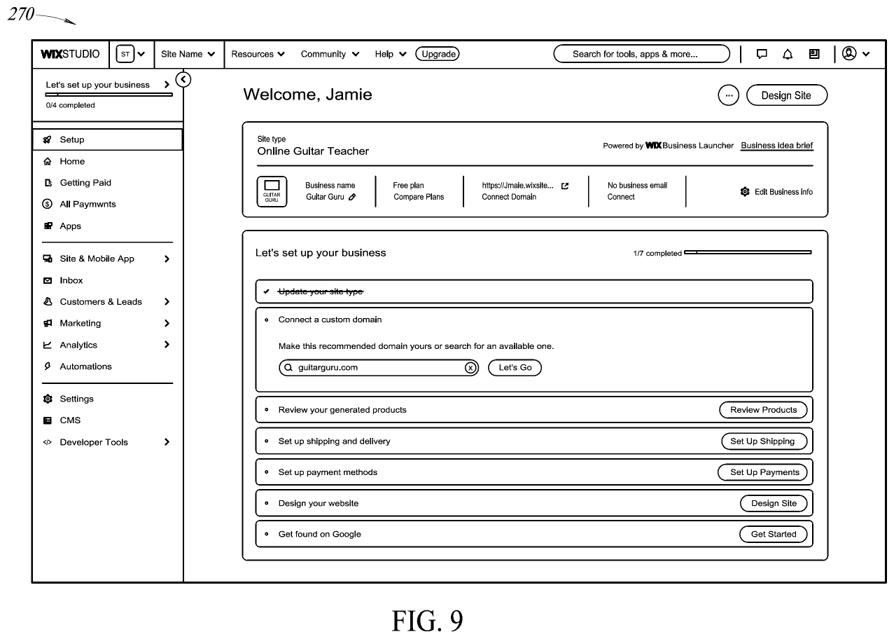

AI bundle creator 262 may generate enterprise names using a dedicated prompt based on the enterprise idea and the entrepreneur's preferred language. The prompt may generate a number of names in categories such as brandable names, single-word names, two-word names separated by spaces, compound words, and names that creatively blend various styles in the language. AI bundle creator 262 may select single best name from among those created by the prompt. In WBS implementations, upon selection of an enterprise and installation of the relevant operational apps, entrepreneur 65 may be directed to a Business Manager (i.e. a business dashboard) 270, as shown in FIG. 9 to which reference is now briefly made, of the WBS from which entrepreneur 65 may configure and operate the enterprise using pre-sets and available tools.

AI bundle creator 262 may also handle legal or regulatory issues with suggested enterprise concepts, such as issues related to IP rights and protection, issues related to privacy, and issues related to regulatory frameworks (such as GDPR, HIPPA, or California's CCPA).

AI marketing operator 264, which may be fine-tuned with data from HPOA marketing plan database 212-6, may generate actionable marketing tasks, and may implement them once the online presence has been installed with the relevant operational apps.

Enterprise plan 263 may outline the strategic framework for the entrepreneur's venture, incorporating insights from high-performance enterprise models and aligning them with the entrepreneur's specific skills and goals. Website 265 and mobile app 267 may represent the digital infrastructure of the online presence, designed to effectively showcase the entrepreneur's enterprise offerings and facilitate customer interactions.

AI marketing operator 264 may leverage data from marketing plan database 212-6 to develop targeted marketing strategies for the entrepreneur's enterprise. These strategies may be integrated into the overall online presence, ensuring cohesive branding and effective customer outreach across all digital touchpoints.

The components of bundle creator module 260 may work in concert to transform the enterprise recommendations generated by presence builder module 250 (as shown in FIG. 7A) into a comprehensive, ready-to-implement enterprise which has an online presence. This process may bridge the gap between enterprise ideation and practical implementation, providing entrepreneurs with the tools and strategies needed to launch their online ventures.

It will be appreciated that tool 200 may represent a significant advance in automated enterprise implementation systems. By leveraging AI-driven analysis of high-performance enterprise models and marketing strategies, tool 200 may provide users with a highly personalized and data-informed foundation for their enterprises. This approach may significantly reduce the complexity and uncertainty often associated with enterprise launches, potentially increasing the likelihood of success for aspiring entrepreneurs in the digital marketplace. The seamless integration of enterprise planning, website creation, and marketing strategy development may offer entrepreneurs a comprehensive solution that addresses the multifaceted challenges of establishing an effective online presence.

It will be appreciated that profile chat AI 241 may conduct its conversation with the entrepreneur in any suitable way, including via chat, structured questionnaires, gesture-based interactions or biometric mechanisms. The conversation may include a set of questions based on a list of required parameters and may be triggered according to the information provided or which is missing from the chat. In addition, profile chat AI 241 may also analyze external information, such as from the entrepreneur's CV document, existing social media or other personal presence, existing web sites, etc., to find the relevant parameters.

It will be appreciated that, for those who already have an enterprise idea in mind, tool 200 may skip chat and HPOA-based entrepreneur to enterprise matcher 240, starting directly with HPOA based online presence selection builder 250. Thus, builder 250 may provide details about the enterprise entrepreneur 65 has in mind, enabling entrepreneur 65 to closely inspect their proposed enterprise, with a full, transparent, and localized mapping of the opportunities and risks ahead.

In this embodiment, builder 250 may additionally generate a localized mapping of similar enterprises near the location of the entrepreneur, listing the potential audience, shipping possibilities, pricing ranges, predicted annual costs (inventory, marketing, accounting), a checklist of mandatory steps to be taken before launching the enterprise, a uniqueness ranking and analysis, and a SWOT (Strengths, Weaknesses, Opportunities, Threats) analysis for the enterprise.

It will be appreciated that online presence recommendation and implementation tool 200 may offer a comprehensive, end-to-end solution that guides entrepreneurs from initial concept to execution. By combining personalized enterprise idea generation, detailed execution planning, and pre-configured digital infrastructure, tool 200 may streamline the entire process of enterprise initiation.

It will further be appreciated that tool 200 may be implemented in systems other than a WBS. In particular, tool 200 may be utilized to generate other types of enterprise communication, media, and presence options, such as mobile applications, virtual or augmented reality environments, or other fully or partially immersive environments. In certain embodiments, tool 200 may also generate or manage conversational applications, such as chat environments (AI-based or otherwise) that provide communication via text, audio, or video, and embedded presence applications, such as social-network pages. These are treated as additional online presence types to which the selection and bundle creation processes described herein apply.

It will be appreciated that, unlike generic enterprise planning tools, tool 200 may leverage artificial intelligence to provide highly tailored recommendations based on the entrepreneur's unique profile, skills, and aspirations. This personalization extends to generating enterprise names, logos, and website content tailored to the suggested enterprise idea.

It will further be appreciated that integrating market intelligence data and insights from high-performance online applications, using the building and hosting information within WBS 100, may allow tool 200 to suggest enterprise ideas with a higher likelihood of viability and success. This data-driven approach helps mitigate the risk of pursuing oversaturated or non-viable enterprise concepts. All of this is done while keeping the privacy and confidentiality of the various examined sites (by using aggregated and derived information, such as is generated by aggregate by feature module 236), and without revealing any specific site information. Moreover, tool 200 may dynamically update its understanding of high-performance enterprise models based on real-world performance data from the WBS platform. This allows the recommendations to evolve over time as market conditions change.

Tool 200 may lower the barriers to entry for entrepreneurs by providing pre-configured WBS platform tools (the operational apps and third-party applications) aligned with the recommended enterprise. This eliminates the need to hunt down, choose, and then integrate these tools individually, significantly reducing the time needed to set up the entrepreneur's enterprise and, particularly, the website operation. Moreover, tool 200 may further reduce barriers to entry by automating much of the technical setup required to launch a new online enterprise, such as creating a logo, generating a website, and installing operation applications.

It will be appreciated that most existing enterprise tools separate and isolate entrepreneurship aspects, leaving entrepreneurs to connect the planning with the execution. Tool 200 may solve this disconnect by combining enterprise ideation, execution plan, and pre-configured digital setup. In addition, tool 200 may generate comprehensive marketing action plans which may provide entrepreneurs with strategic guidance often lacking in traditional business planning resources. This feature helps bridge the knowledge gap for individuals without prior entrepreneurial experience.

It will further be appreciated that tool 200 may analyze patterns from high-performance WBS sites and may also incorporate market intelligence data to identify promising enterprise models and market trends.

Finally, it will be appreciated that tool 200 may seamlessly integrate various data sources and AI models. For example, site summarizer 232 may leverage NLP techniques to automatically generate concise descriptions of existing high-performance websites, which are then fed into online presence creator 218 for the enterprise ideation and implementation.

Unless specifically stated otherwise, as apparent from the preceding discussions, it is appreciated that, throughout the specification, discussions utilizing terms such as “analyzing”, “generating”, “processing,” “computing,” “calculating,” “determining,” or the like, refer to the action and/or processes of a general purpose computer or system of any type, such as a client/server system, mobile computing devices, smart appliances, cloud computing units, artificial intelligence (AI) and/or machine learning (ML) units, or similar electronic computing devices that manipulate and/or transform data within the computing system's registers and/or memories into other data within the computing system's memories, registers or other such information storage, transmission or display devices.

The inventive elements may be implemented on a suitable apparatus. This apparatus may be specially constructed for the desired purposes, or it may comprise a computing device or system typically having at least one processor and at least one memory, selectively activated or reconfigured by a computer program, code or prompt. The resultant apparatus, when instructed by program, code or prompt, may turn the general-purpose computer into inventive elements as discussed herein. The program, code or prompt may define the inventive device in operation with the computer platform for which it is desired. Such program, code or prompt may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing programs, code or prompts. The computer readable storage medium may also be implemented in cloud storage.

Some general-purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system to define features of online presences, the system comprising:
a high-performance metric analyzer to analyze hosting platform data to identify high-performance online applications (HPOAs) as a function of performance indicators and to store information about said HPOAs in a HPOA database;
an HPOA summarizer to generate summaries of content of said HPOAs; and
a feature definer to define features of said HPOAs at least from said summaries.

2. The system according to claim 1 wherein said performance indicators are at least one of: traffic, income, and end user engagement.

3. The system according to claim 1 wherein said HPOA summarizer utilizes a large language model (LLM) to generate said summaries of content of said high-performance online applications.

4. The system according to claim 1 wherein said features comprise at least one enterprise phrase and at least one enterprise definition used to define or describe an enterprise of one of said high-performance online applications.

5. The system according to claim 4 further comprising an aggregate by feature module to compile and organize said features across multiple high-performance online applications.

6. The system according to claim 5 wherein said aggregate by feature module determines a term frequency-inverse document frequency (TF-IDF) per high-performance online application.

7. The system according to claim 1 further comprising:
an enterprise aspect extractor to receive data from said HPOA database and to extract various enterprise aspects from said HPOAs; and
a plurality of aspect databases storing specific aspects of enterprises extracted by said enterprise aspect extractor.

8. A matcher to match a profile of an entrepreneur to features of a high-performance online app (HPOA), the matcher comprising:
a HPOA processor to extract a set of HPOAs at least from databases of website and online application building systems and of hosting platforms and to generate an HPOA feature database of features of said HPOAs from said extracted set;
an HPOA-based profiler, at least fine-tuned with at least a profiler portion of said HPOAs, to receive from an entrepreneur information about his/her skills, hobbies, and interests and to generate an entrepreneur profile in response; and
an HPOA-based entrepreneur to enterprise matcher to match said entrepreneur profile with a set of features of said HPOA feature database.

9. The matcher according to claim 8 and also comprising:
a HPOA-based online presence selection builder, at least fine-tuned with at least operational app and marketing portions of said HPOAs, to receive said set of features from said matcher and to generate a set of candidate enterprises from said set of features; and
a HPOA-based selected online presence bundle creator, at least fine-tuned with at least a bundle data portion of said HPOAs, to construct a comprehensive online presence bundle for a selected enterprise from among said set of candidate enterprises, wherein said bundle creator generates at least a business plan, a website, and a mobile app for said selected enterprise.

10. A method to define features of online presences, the method comprising:
analyzing hosting platform data to identify high-performance online applications (HPOAs) as a function of performance indicators;
storing information about said HPOAs in a HPOA database;
generating summaries of content of said HPOAs; and
defining features of said HPOAs at least from said summaries.

11. The method according to claim 10, wherein said performance indicators are at least one of: traffic, income, and end user engagement.

12. The method according to claim 10, wherein said generating utilizes a large language model (LLM).

13. The method according to claim 10, wherein said defining comprises defining at least one enterprise phrase and at least one enterprise definition used to describe an enterprise of one of said high-performance online applications.

14. The method according to claim 13, further comprising compiling and organizing said features across multiple HPOAs.

15. The method according to claim 14, wherein said compiling and organizing comprises determining a term frequency-inverse document frequency (TF-IDF) per high-performance online application.

16. The method according to claim 10, further comprising:
extracting various enterprise aspects from said HPOAs stored in said HPOA database; and
storing specific aspects of enterprises in separate aspect databases.

17. A method to match a profile of an entrepreneur to features of a high-performance online app (HPOA), the method comprising:
extracting a set of HPOAs from databases and generating an HPOA feature database of features of said HPOAs from said extracted set;
receiving from an entrepreneur information about their skills, hobbies, and interests and generating an entrepreneur profile in response, wherein said generating is at least fine-tuned with a profiler portion of said HPOAs; and
matching said entrepreneur profile with a set of features of said HPOA feature database.

18. The method according to claim 17, further comprising:
generating a set of candidate enterprises from the set of features resulting from said matching, wherein said generating is at least fine-tuned with operational app and marketing portions of said HPOAs; and
constructing a comprehensive online presence bundle for a selected enterprise from among said set of candidate enterprises by generating at least a business plan, a website, and a mobile app for said selected enterprise, wherein said constructing is at least fine-tuned with a bundle data portion of said HPOAs.
